(19) United States
(12) Patent Application Publication
(10) Pub. No.: US 2005/0171777 A1
(43) Pub. Date: Aug. 4, 2005

(54) Generation of synthetic speech

(76) Inventors: David Moore, Oxford (GB); John Coleman, Oxford (GB)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/512,817

(22) PCT Filed: Apr. 29, 2003
(86) PCT No.: PCT/GB03/01852

(30) Foreign Application Priority Data
Apr. 29, 2002 (GB) 0209770.7

(51) Int. Cl. G10L 13/00

(52) U.S. Cl. 704/265

(57) ABSTRACT

There is disclosed a method of generating synthetic speech sound data relating to first and second utterances. Interpolation between or extrapolation from first and second sets of parameters encoding said utterances results in a third set of parameters used to synthesise the synthetic speech sound. Each set of parameters preferably includes separate source parameters and spectral parameters derived using linear prediction coding. Related methods of trailing and diagnosis, and related apparatus are also disclosed.

The invention relates to the generation of a synthetic speech sound related to first and second utterances, and in particular to the generation of data representing a synthetic speech sound by interpolation between or extrapolation from recorded speech samples of the first and second utterances.

It is known to use intervals of musical pitch to train the musical listening skills of human subjects. WO99/34345 describes training tasks in which a subject is asked to distinguish between, or identify the pitch relationship between two or more musical tones of different fundamental frequencies, played together or consecutively.

A similar training method can be used to train language listening skills. In UK patent application 0102597.2 a method is described in which first and second end point phonemes, for example /I/ and /e/, are synthesised from their well known principal formants. Each of the phonemes /I/ and /e/ is synthesised using identical upper and middle formants at 2900 Hz and 2000 Hz respectively, while the lower formant is at 410 Hz for /I/ and 600 Hz for /e/. Pairs of training phonemes are then synthesised by altering the frequency of the lower formant to reduce the contrast between the training phonemes, and to make the subject's task of distinguishing between the training phonemes more challenging.

The method described in UK application 0102597.2 may be applied to a range of phonetic contrasts, by adopting appropriate formant models, frequency variations and timing variations. However, the training phonemes generated do not always sound natural, and obtaining a variety of natural sounding voices used is very difficult. The effectiveness of training using such phonemes may thereby be limited. Moreover, careful and extensive work is required to generate each new pair of end point phonemes and to define the mechanism by which the range of intermediate training phonemes are to be formed.

Accordingly, the invention provides a method of generating data representing a synthetic speech sound related to first and second utterances, comprising the steps of:
providing first and second sets of parameters encoding first and second recorded speech samples of the first and second utterances;
interpolating between or extrapolating from the first and second sets of parameters to form a third set of parameters; and
generating the synthetic speech sound from the third set of parameters.

Using samples from real speech realises a number of advantages. There is no need to analyse the formant structure of the end point speech samples or to design a mode of extrapolation or interpolation, for example by variation of a particular formant. The end point speech samples are more realistic, and a wide range of different first and second utterances can easily be used, including phonemes, words and other sounds. The process is reasonably straightforward to automate, and the method could also be extended to non speech sounds, such as musical, mechanical, animal, medical and other sounds.

Each speech sample may be an averaged utterance of several samples taken from a single or from several speakers.

The recorded speech samples may be encoded in a variety of ways to permit extrapolation/interpolation. A fourier or other general purpose spectral analysis may be used, or formant analysis, either manual or automated. Preferably, however, the parameters are generated by means of linear prediction coding. The synthetic speech sound may be generated by applying a suitable synthesis step to the extrapolated or interpolated parameters, for example a step of linear prediction synthesis or formant synthesis as appropriate.

When linear prediction coding is used the first and second sets of parameters preferably comprise a respective set of source parameters and a respective set of spectral parameters. Preferably, the source parameters for each speech sample include one or more of fundamental frequency, probability of voicing, a measure of amplitude and largest cross correlation found at any lag of the respective recorded speech sample, each parameter being derived for each of a plurality of time frames for each recorded speech sample.

Preferably, each set of spectral parameters comprises a plurality of reflection coefficients calculated for each of a plurality of time frames of the respective recorded speech sample.

Surprisingly, linear interpolation or extrapolation of the spectral reflection coefficients results in a synthetic speech sound which, from the view point of a subjective listener, correctly relates to the first and second recorded speech samples, so that the method is useful for training subjects by manipulating the contrast between test sounds.

Preferably, the step of interpolating or extrapolating comprises the steps of: interpolating between or extrapolating from the spectral coefficients of the first and second sets of parameters; and using the source parameters of only a selected one of the first and second sets of parameters. This results in a continuum of intermediate synthetic speech sounds improved for use in listening training exercises, by matching the end point sounds more closely. The source parameters to use may be selected by generating a first test synthetic speech sound from the spectral parameters of the first set of parameters and the source parameters of the second set of parameters; generating a second test synthetic speech sound from the spectral parameters of the second set of parameters and the source parameters of the first set of parameters; and selecting the source parameters for use in the step of interpolation by comparison of the first and second synthetic test speech sounds according to predetermined criteria.

Preferably, the source parameters used to generate the more natural sounding of the first and second synthetic test speech sounds are chosen for use in the step of interpolating.

A single selected set of source parameters may only be appropriate when the first and second utterances are not contrastive. If they are contrastive, for example having different voicing patterns, then interpolation/extrapolation of the source parameters of the two recorded speech samples may be used.

Preferably, the method further comprises the steps of: providing respective first and second recorded speech samples of the first and second utterances; and encoding the first and second speech samples to generate the first and second sets of parameters. These steps may be carried out as a preliminary stage, with the resulting parameters and related data such as selection of source parameters provided for use with a computer software package which carries out the step of generating an intermediate or extrapolated synthetic speech sound, for example for the purposes of listening training.

Preferably, the method further comprises the step of aligning the first and second recorded speech samples prior to encoding so that the waveforms of the samples are synchronized in time. Other preprocessing steps may be applied.

The invention also provides a method of training a subject to discriminate between first and second utterances, the method comprising the steps of:
generating a synthetic speech sound by extrapolation from said first and second utterances, said synthetic speech sound lying outside a range of variation defined by the first and second utterances;
determining whether the subject is capable of discriminating between said synthetic speech sound and another test speech sound related to said first and second utterances. The synthetic speech sound may be generated by any of the methods set out above. By providing a test sound generated by extrapolation outside the range lying directly between the first and second utterances, the contrast between these utterances is emphasised, thus assisting training subjects in appropriate discrimination.

Preferably, said other test speech sound is also generated by extrapolation from said first and second utterances.

The invention also provides a computer readable medium comprising computer program instructions operable to carry out and an apparatus comprising means adapted to carry out any of the methods set out above, and a computer readable medium on which is written data representing or encoding a synthetic speech sound generated using the steps of any of the above methods. The invention also provides apparatus for carrying out appropriate steps of the above methods.

Embodiments of the invention will now be described, by way of example only, with reference to the accompanying drawings, of which:

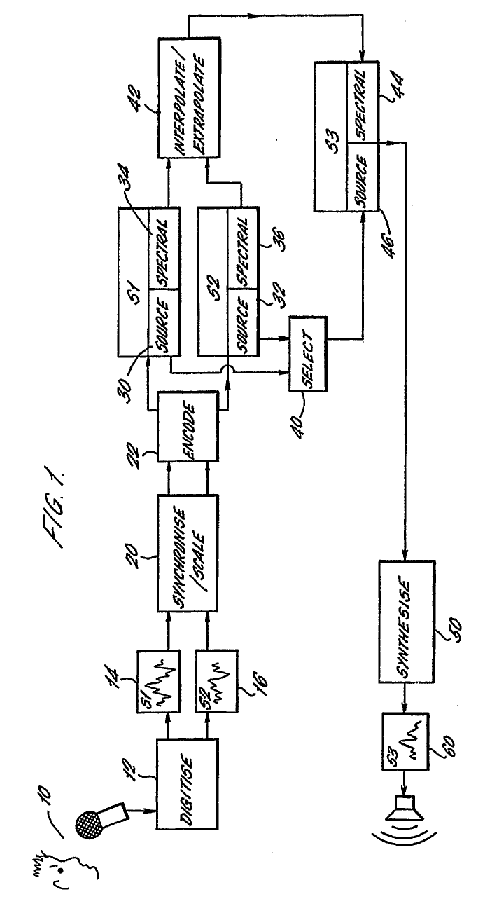

FIG. 1 illustrates the steps of a method for generating a synthetic speech sound interpolated between or extrapolated away from two recorded speech samples;

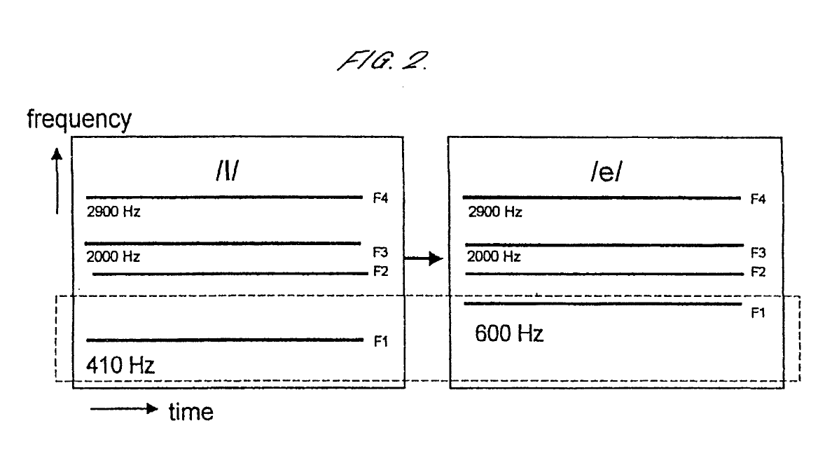

FIG. 2 illustrates the formant structure of /I/ and /e/ phonemes;

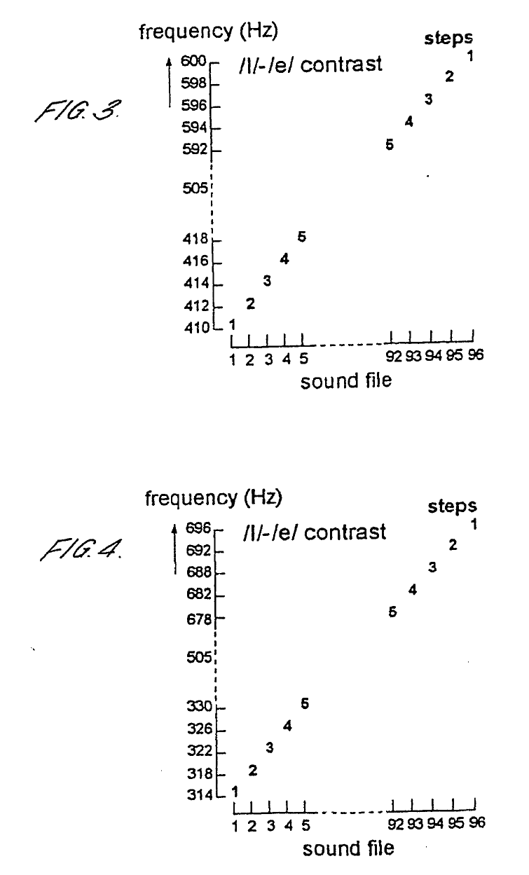

FIGS. 3 to 6 show graphs of synthetic speech sound files (abscissa) against lower formant frequency (ordinate) of data sets for training listening skills based on /I/ and /e/ phonemes;

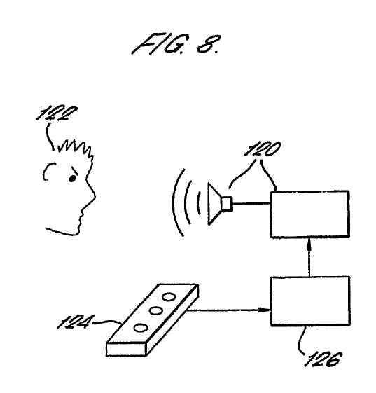

FIG. 7 shows apparatus for generating synthetic speech sounds; and

FIG. 8 shows apparatus for training or testing a subject using synthetic speech sounds.

Embodiments of the invention provide for the preparation of two recorded speech samples exemplifying a phonemic contrast between two utterances, for example “bee” and “dee”, and for the generation of a synthetic speech sound related to the two speech samples. A single, a plurality or a continuum of synthetic speech sounds may be generated, intermediate between, and/or extending beyond the two speech samples, with the required spacing and range for a particular language listening training task.

A preferred embodiment of the invention is illustrated in FIG. 1. Instances of the two utterances spoken by a human subject are recorded 10 and digitised 12 at an appropriate sampling rate, such as 11025 Hz, and with an amplitude resolution, such as 16 bit, appropriate to the fidelity of the desired audio output to produce first and second recorded speech samples 14, 16. The recorded speech samples are manually edited at step 20 so that the sounds in each file are accurately synchronised with each other in time and their amplitudes are scaled to prevent numerical overflows in subsequent steps.

The synchronised, scaled speech samples are then encoded 22 into a plurality of acoustic parameters, such that those acoustic parameters can later be used to synthesise speech samples which are very similar to the original speech samples. In the preferred embodiment the encoding is carried out using linear prediction analysis. This is a widely used technique for speech signal coding: see Schroeder, M. R. (1985) Linear Predictive Coding of Speech: Review and Current Directions, IEEE Communications Magazine 23 (8), 54-61 for a general discussion, or Press, W. H. et al. (1992) Numerical Recipes in C: The Art of Scientific Computing, Second Edition, Cambridge University Press, for specific algorithms. The linear prediction coding tools used by the inventors were from the ESPS signal processing system issued by Entropics Corporation, Washington D.C.

In the preferred embodiment each speech sample is encoded to yield a set of source parameters 30, 32 and a set of spectral parameters 34, 36. The source parameters 30, 32 are obtained using the ESPS get_f0 routine described in Talkin, D. (1995), “A robust algorithm for pitch tracking (RAPT)”, in Kleijn, W. B. and Paliwal, K. K. eds., “Speech coding and synthesis”, Elsevier, N.Y. The source parameters 30, 32 are required, for example, to define the loudness and fundamental frequency of part of a sound, and whether the part is voiced or voiceless. The source parameters used in the present embodiment include an estimate of the fundamental frequency of a speech sample, a probability of voicing (an estimate of whether the speech is voiced or voiceless), a local root mean squared signal amplitude, and the largest cross correlation found at any lag. The source parameters are updated at a suitable rate, once in each encoding time frame of 13.6 ms.

The spectral parameters 34, 36 of the preferred embodiment comprise 17 reflection coefficients for each time frame, calculated using the method of Burg, J. P. (1968) Reprinted in Childers, D. G. (ed.) (1978) Modern Spectral Analysis, IEEE Press, New York. A preemphasis factor of 0.95 was applied to the input signals.

The source and spectral parameters yielded from encoding 22 of the first and second recorded speech samples 14, 16 can be used to create synthetic duplicates of the recorded speech samples by using linear prediction synthesis, for example as discussed in Markel, J. D. and A. H. Gray Jr. (1976) “Linear Prediction of Speech”, Springer-Verlag, New York. In the preferred embodiment the ESPS linear prediction synthesis routine “lp_syn” described in Talkin D. and J. Rowley (1990) “Pitch-Synchronous analysis and synthesis for TTS systems”, In G. Bailly and C. Benait, eds., Proceedings of the ESCA Workshop on Speech Synthesis, Grenable, France: Institut de la Communication Parleé, is used for synthesis from the encoded parameters.

In order to provide an interpolation between or extrapolation from the first and second recorded speech samples which is suitable for listening skills training it is preferable to use the same source parameter values 30 or 32 for all of a range of generated output synthetic speech sounds. To this end, a first test synthetic speech sound is synthesised using the spectral parameters 34 of the first speech sample 14 with the source parameters 32 of the second speech sample, and a second test synthetic speech sound is synthesised using the spectral parameters 36 of the second speech sample 16 with the source parameters 30 of the first speech sample 14. Auditory examination of the two test sounds is used to determine, subjectively, which one is more natural sounding. The source parameters of the more natural sounding of the two test sounds are selected at step 40 for use in synthesis of the interpolated or extrapolated synthetic speech sounds over the whole desired range. As alternatives more suitable to automation of the process, one of the sets of source parameters could be selected arbitrarily, or an interpolation/extrapolation between/from or single average of the two sets could be used. Indeed use of a single set of source parameters may be inappropriate if the two utterances are contrastive, for example if one is voiced and the other unvoiced. In cases such as these, extrapolation/interpolation between the two sets of source parameters may be preferred.

Spectral parameters 44 for one or more synthetic speech sounds 44 intermediate between the spectral parameters 34, 36 of the first and second speech samples 14, 16 are formed by interpolation 42, preferably linear interpolation, between the two sets of spectral parameters 34, 36. Alternatively, or additionally, spectral parameters 44 for synthetic speech sounds lying outside the natural range of variation between the first and second speech samples 14, 16 can be generated by appropriate, preferably linear, extrapolation from the two sets of spectral parameters 34, 36.

The interpolated spectral parameters 44 are used in combination with the selected source parameters 46 in a step of linear prediction synthesis 50 to generate data representing an output synthetic speech sound 60. A plurality of such output speech sounds may be generated at discrete intervals between and/or beyond the end points for use in listening skills training or other applications.

In another embodiment of the invention, the processing of the utterance speech samples is carried out in advance and the encoded speech samples are made available to software adapted to carry out the interpolation and/or extrapolation described above and to generate the resulting synthetic speech sounds as desired. This software may be incorporated into listening training software provided, for example, on a CDROM, for use on a conventional personal computer equipped with audio reproduction facilities for replay of the synthetic speech sounds.

The methods described above may be varied in a number of ways. Instead of encoding the first and second recorded speech samples using linear prediction coding, formant synthesiser parameters of the samples may be obtained using acoustic analysis or by using a formant synthesis-by-rule program. Suitable acoustic analysis is discussed in Coleman, J. S. and A. Slater (2001) “Estimation of parameters for the Klatt formant synthesiser”, In R. Damper, ed., “Data Mining Techniques in Speech Synthesis”, Kluver, Boston, USA, pp215-238. A suitable formant synthesis-by-rule program is discussed in Dirksen, A and J. S. Coleman (1997) All-Prosodic Synthesis Architecture, In J. P. H. Van Santen, et al., eds. Progress in Speech Synthesis, Springer-Verlag, New York, pp91-108. Intermediate formant parameters may then be derived by interpolation and/or extrapolation, and resulting speech signals synthesised by means of a formant synthesiser. Other speech and audio signal encoding schemes may similarly be used.

The method may comprise a number of manual steps or could be fully automated, in either case being implemented or supported by appropriate computer hardware and software implemented on one or more computer systems, the software being written, where appropriate, on one or more computer readable media such as CDROMS.

Uses of synthetic speech sounds such as those discussed above in language listening skills training will now be described. A set of speech sounds forming a progression from one end point utterance, or phoneme to another is used. The set of speech sounds may be generated by interpolating between and/or extrapolating beyond encoded real speech samples, as discussed above, or may be generated using other techniques such as formant synthesis. Subjects are first trained to discriminate between the real or end point phonemes and, as their performance improves, they progress to the more difficult discrimination between speech sounds which are closer together. Training converges on the border between the two phonemes.

The end points of a set of speech sounds progressing from /I/ to /e/ are illustrated in FIG. 2. The upper and middle formants remain at 2900 Hz and 2000 Hz respectively throughout the progression, while the lower formant varies between 410 Hz and 600 Hz. A set of 96 speech sounds progressing from /I/ to /e/is illustrated in FIG. 3, in which the frequency of the lower formant is plotted on the ordinate against an index into the set of speech sounds on the abscissa. The first training step is to distinguish between the speech sounds in which the lower formant has frequencies of 410 Hz and 600 Hz, with a training progression towards judgements near 505 Hz. The same principles can apply to any set or pair of phonemes or other utterances, for example by using the methods described herein to generate the intermediate speech sounds.

Although the training method illustrated in FIGS. 2 and 3 is effective, it may be improved by extending the range of steps beyond the real phonemes or other end points, and by training more intensively around a real phoneme or utterance. FIG. 4 illustrates a set of speech sounds forming a progression between, but extending beyond end point /I/ and /e/phonemes, by extrapolation, again with the frequency of the lower formant plotted as the ordinate. Training begins at the ends of the training set, with the lower formant having frequencies of 314 Hz and 696 Hz instead of 410 Hz and 600 Hz. To retain the same number of speech sounds as for FIG. 3 the frequency step of the lower formant is increased. This type of training may be suitable for a subject unable to use the method illustrated in FIG. 3, because the contrast between the two phonemes is exaggerated at the start of the training. However, the exaggerated phonemes may not sound very natural or like real speech sounds if the extrapolation is too extreme.

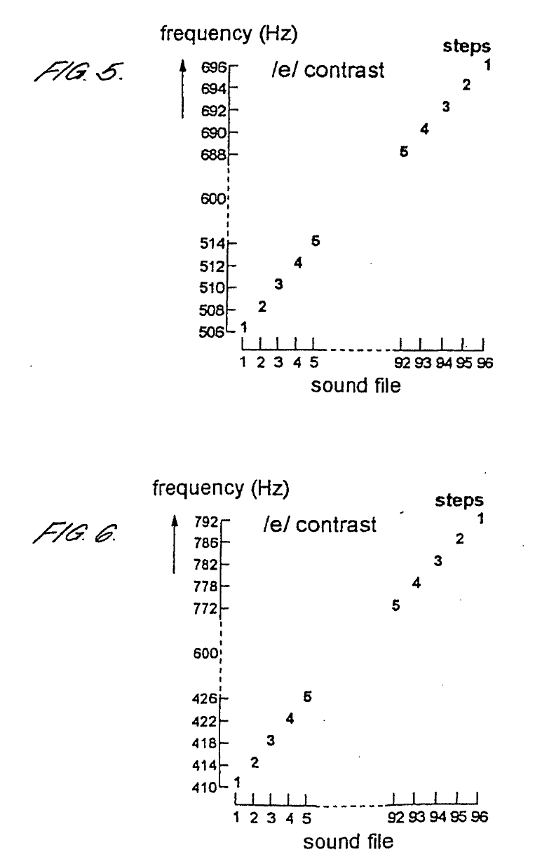

A set of speech sounds forming a progression extending either side of a central /e/ phoneme is illustrated in FIG. 5, in which the frequency of the lower formant is plotted as the ordinate. The extension away from the /e/phoneme is defined by interpolation towards or extrapolation away from another reference phoneme, or utterance, in this case /I/. The reference phoneme need not form part of the set of speech sounds, and in FIG. 5 lies off the graph. Training begins at the ends of the set of speech sounds and moves towards discrimination between sounds at the centre of the set, so that training focuses on the real phoneme or utterance.

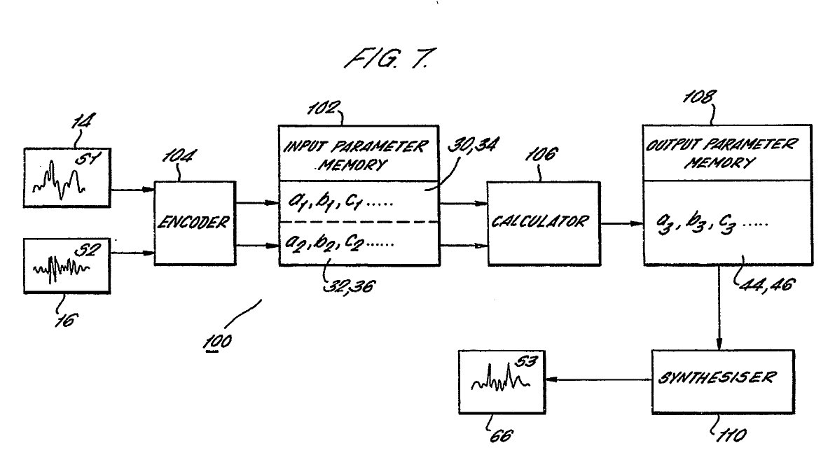

FIG. 6 illustrates a set of speech sounds combining the characteristics of those illustrated in FIGS. 4 and 5. The /e/ phoneme lies at the centre of the training set, which extends to /I/ in one direction, and to a much high frequency of lower formant, plotted on the ordinate, in the other direction.

Apparatus 100 for generating data representing a synthetic speech sound related to first and second utterances, according to the methods already described, is illustrated in FIG. 7. An input parameter memory 102 receives and stores first and second sets of parameters 30, 32, 34, 36 created from first and second recorded speech samples 14, 16 of first and second utterances by encoder 104. A calculator element 106 is adapted to interpolate between or extrapolate from the first and second sets of parameters to generate a third set of parameters 44, 46 which are stored in an output parameter memory 108. A synthesiser element 110 then generates the synthetic speech sound data 60 from the third set of parameters. Generally, the apparatus may be implemented using well known general purpose computer apparatus, such as a personal computer with appropriate input and output devices.

The apparatus may be further arranged to carry out any of the method steps already described using appropriate processing elements which may be implemented using software. The apparatus may, as alternatives, exclude the encoder element 104, and/or the synthesiser element 110, instead outputting speech sound parameters for use later on by a separate apparatus including an appropriate synthesiser element. The apparatus may be arranged to generate a range of respective third sets of parameters and/or synthetic speech sounds from a corresponding pair of input recorded speech samples or utterances.

The synthetic speech sounds may be used to train or test a subject, for example as already described, using an apparatus such as that shown in FIG. 8. Synthetic speech sounds which have been or are concurrently generated as described above are reproduced using a playback device 120. Responses of a subject 122, for example when deciding if two sounds reproduced using the playback device 120 are the same or not, are received using an input device 124, such as a computer keyboard, pointer device or other arrangement of switches. The received responses are used by logic 126 to control the synthesis or generation and playback of further speech sounds by the playback device 120 to enable the training or testing to proceed as desired.

1. A method of training a subject to discriminate between first and second utterances, the method comprising the steps of:
generating data representing a synthetic speech sound by extrapolation from or interpolation between said first and second utterances, said synthetic speech sound lying respectively outside or inside a range of variation defined by the first and second utterances;
reproducing the synthetic speech sound from the data; and
determining whether the subject is capable of discriminating between said synthetic speech sound and another test speech sound related to said first and second utterances.

2. A method of testing a subject, comprising the steps of:
generating data representing a synthetic speech sound by extrapolation from or interpolation between first and second utterances, said synthetic speech sound lying respectively outside or inside a range of variation defined by the first and second utterances;
reproducing the synthetic speech sound from the data; and
determining whether the subject is capable of discriminating between said synthetic speech sound and another test speech sound related to said first and second utterances.

3. The method of claim 1 or 2 wherein said another test speech sound is also generated by extrapolation from or interpolation between said first and second utterances.

4. The method of any of claims 1 to 3 further comprising the steps of:
in response to the step of determining, generating further data representing a further synthetic speech sound by extrapolation from or interpolation between said first and second utterances; and
reproducing said further synthetic speech sound from said further data.

5. The method of any of claims 1 to 4 further comprising the step of:
providing first and second sets of parameters encoding first and second recorded speech samples of said first and second utterances,
each step of extrapolation or interpolation comprising extrapolating from or interpolating between the first and second sets of parameters to form a third set of parameters,
each step of reproducing comprising generating the synthetic speech sound from the respective third set of parameters.

6. A method of generating data representing a synthetic speech sound related to first and second utterances, comprising the steps of:
providing first and second sets of parameters encoding first and second recorded speech samples of the first and second utterances;
interpolating between or extrapolating from the first and second sets of parameters to form a third set of parameters; and
generating the synthetic speech sound data from the third set of parameters.

7. The method of claim 6 wherein each of the first and second sets of parameters comprises a respective set of source parameters and a respective set of spectral parameters, the spectral parameters being derived by linear prediction coding.

8. The method of claim 7 wherein each set of source parameters includes one or more of a fundamental frequency, a probability of voicing, a measure of amplitude and a largest cross correlation found at any lag of the respective recorded speech sample.

9. The method of either of claims 7 or 8 wherein each set of spectral parameters comprises a plurality of reflection coefficients calculated for each of a plurality of time frames the respective recorded speech sample.

10. The method of any of claims 7 to 9 wherein the step of generating the data representing the synthetic speech sound comprises the step of applying linear prediction synthesis to the third set of parameters.

11. The method of any of claims 7 to 10 wherein the step of interpolating or extrapolating comprises the steps of:
interpolating between or extrapolating from the spectral coefficients of the first and second sets of parameters; and
using the source parameters of only a selected one of the first and second sets of parameters.

12. The method of claim 11 further comprising the steps of:
generating data representing a first test synthetic speech sound from the spectral parameters of the first set of parameters and the source parameters of the second set of parameters;
generating data representing a second test synthetic speech sound from the spectral parameters of the second set of parameters and the source parameters of the first set of parameters; and
selecting the source parameters for use in the step of interpolation by comparison of the first and second synthetic test speech sounds according to predetermined criteria.

13. The method of claim 12 wherein, in the step of selecting, the source parameters used to generate the more natural sounding of the first and second synthetic test speech sounds are chosen for use in the step of interpolating.

14. The method of claim 6 wherein each of the first and second sets of parameters comprises a respective set of formant parameters.

15. The method of any of claims 6 to 14 further comprising the steps of:
providing respective first and second recorded speech samples of the first and second utterances; and
encoding the first and second speech samples to generate the first and second sets of parameters.

16. The method of claim 15 further comprising the step of aligning the first and second recorded speech samples prior to the step of encoding so that the waveforms of the samples are synchronized in time.

17. The method of any of claims 1 to 5 wherein the data representing the synthetic speech sound is generated using the method of any of claims 6 to 16.

18. Apparatus for generating data representing a synthetic speech sound related to first and second utterances, comprising:
an input parameter memory arranged to receive and store first and second sets of parameters encoding first and second recorded speech samples of the first and second utterances;
a speech sound calculator arranged to interpolate between or extrapolate from the first and second sets of parameters to form a third set of parameters; and
a synthesiser arranged to generate the synthetic speech sound data from the third set of parameters.

19. The apparatus of claim 18 wherein each of the first and second sets of parameters comprises a respective set of source parameters and a respective set of spectral parameters, the spectral parameters being derived by linear prediction coding.

20. The apparatus of claim 19 wherein each set of source parameters includes one or more of a fundamental frequency, a probability of voicing, a measure of amplitude and a largest cross correlation found at any lag of the respective recorded speech sample.

21. The apparatus of either of claims 19 or 20 wherein each set of spectral parameters comprises a plurality of reflection coefficients calculated for each of a plurality of time frames the respective recorded speech sample.

22. The apparatus of any of claims 19 to 21 wherein, to generate the data representing the synthetic speech sound, the synthesiser is arranged to apply linear prediction synthesis to the third set of parameters.

23. The apparatus of any of claims 19 to 22 wherein the calculator is arranged to:
interpolate between or extrapolate from the spectral coefficients of the first and second sets of parameters; and to
use the source parameters of only a selected one of the first and second sets of parameters.

24. The apparatus of claim 23 further arranged to:
generate data representing a first test synthetic speech sound from the spectral parameters of the first set of parameters and the source parameters of the second set of parameters;
generate data representing a second test synthetic speech sound from the spectral parameters of the second set of parameters and the source parameters of the first set of parameters; and
select the source parameters for use in the step of interpolation by comparison of the first and second synthetic test speech sounds according to predetermined criteria.

25. Apparatus for training a subject to discriminate between first and second utterances, comprising:
a playback device for reproducing a synthetic speech sound from data representing the synthetic speech sound, generated by extrapolation from or interpolation between said first and second utterances, said synthetic speech sound respectively lying outside or within a range of variation defined by the first and second utterances;
an input device; and
logic for determining, from signals received from said input device, whether the subject is capable of discriminating between said synthetic speech sound and another test speech sound related to said first and second utterances.

26. The apparatus of claim 25 wherein said other test speech sound is also generated by extrapolation from or interpolation between said first and second utterances.

27. The apparatus of claim 25 wherein the logic is adapted to cause the playback device to reproduce a further synthetic speech sound, dependent on the signals received from the input device.

28. A computer readable medium comprising computer program instructions arranged to carry out the method steps of any of claims 1 to 17 when executed on a computer.

29. A computer readable medium comprising data representing a synthetic speech sound generated according to the method steps of any of claims 6 to 16.
